(19) United States
(12) Patent Application Publication
(10) Pub. No.: US 2005/0110189 A1
(43) Pub. Date: May 26, 2005

(54) Method for affixing panel forms, liners and other objects to material surfaces coated with a releasing agent

(76) Inventor: Bobby Gene Miller, Washougal, WA (US)

Correspondence Address: SMITH-HILL AND BEDELL, 12670 N W BARNES ROAD, SUITE 104, PORTLAND, OR, 97229, US

(21) Appl. No.: 10/789,269

(22) Filed: Feb. 26, 2004

Related U.S. Application Data
(60) Provisional application No. 60/450,651, filed on Feb. 26, 2003.
(60) Provisional application No. 60/513,296, filed on Oct. 21, 2003.

(51) Int. Cl. B29C 31/00

(52) U.S. Cl. 264/259; 264/157

(57) ABSTRACT

There is disclosed herein an improved method applicable to the construction industry wherein one or more spray adhesive products are utilized to affix panel forms, liners and other objects to common construction material surfaces, including surfaces coated with a releasing agent.

### CROSS-REFERENCE TO RELATED APPLICATIONS

This application claims benefit of Provisional Application No. 60/450,651 filed Feb. 26, 2003 and Provisional Application No. 60/513,296 filed Oct. 21, 2003.

### BACKGROUND OF THE INVENTION

There is disclosed herein an improved method applicable to the construction industry wherein one or more spray adhesive products are utilized to affix panel forms, liners and other objects to common construction material surfaces, including surfaces coated with a releasing agent, as follows:

### DEFINITIONS

The term “adhesive material” as used in this specification includes any adhesive material that is capable of being affixed or bonded to a surface covered with a non-stick concrete releasing agent, commonly referred to as a “bond-breaker”.

One suitable adhesive material is a canister-based low and non-VOC aerosol adhesive. The aerosol adhesive typically includes a high solids polymeric base, a hexane acetone solvent mixture and a compressed gas dissolved within the solvent. The compressed gas typically includes carbon dioxide, nitrogen, nitrous oxide and air. The aerosol adhesive is adapted to be filled into a canister including a hose connected to the canister and a spray gun connected to the hose. The adhesive is commercially available from Westech Aerosol Corporation under the designation “High Strength Spray Adhesive”, and is more particularly described in U.S. Patent Publication No. 20020161056 and others as may be applied for from time to time.

Another suitable adhesive contains, in percent by weight, dimethyl ether 30-40, acetone 10-20, pentane 10-20, nonvolatile components (synthetic elastomers, hydrocarbon resin, antioxidant and u.v. absorber) 10-20, cyclohexane 10-20, and pentane 7-13, and is commercially available from 3M Corporation under the designation 3M™ synthetic elastomer Hi-Strength 90 Contact Adhesive.

Another suitable adhesive material is a non-flammable aerosolized adhesive with pressure sensitive properties consisting of one or more synthetic polymers, methylene chloride and a proprietary blend of propellant material and is commercially available from International Tool Works/The American Chemical Company (ITW/TACC) under the designation “T987 Non-Flammable/High Temperature/High Strength/Low VOC Adhesive.”

Another suitable adhesive material is an aerosolized adhesive with pressure sensitive properties consisting of one or more synthetic polymers, and a proprietary blend of propellant material and is commercially available from International Tool Works/The American Chemical Company (ITW/TACC) under the designation “TACC M-206 Adhesive.”

Another suitable adhesive material is a water-resistant aerosolized adhesive with pressure sensitive properties consisting of one or more synthetic polymers, and a proprietary blend of propellant material and is commercially available from Apollo Industries, Inc. under the designation “Extra Strength Spray Adhesive.”

Another suitable adhesive material is a high temperature-resistant aerosolized adhesive with pressure sensitive properties consisting of one or more synthetic rubbers, organic solvents and a proprietary blend of propellant material and is commercially available from DAP, Inc. under the designation “Weldwood® Extra Strength Spray Adhesive.”

Another suitable adhesive material is a water-resistant aerosolized adhesive with pressure sensitive properties consisting of one or more synthetic polymers, and a proprietary blend of propellant material and is commercially available from Columbia Cement Co., Inc./Formica® Corporation under the designation “Formica® 200 Contact Adhesive.”

Another suitable adhesive material is an aerosolized adhesive with pressure sensitive properties consisting of one or more synthetic polymers, and a proprietary blend of propellant material and is commercially available from Virginia KMP Corporation under the designation “Virginia Spray Adhesive—SA16.”

The term “blockout”, as used in this specification includes any indentation formed into the exterior surface of a concrete tilt-up panel at the time it is poured.

The term “chamfer” as used in this specification includes a beveled edge, a groove or fluting formed into the exterior surface of a concrete tilt-up panel at the time it is poured.

The term “concrete” as used in this specification includes Portland Cement concrete and similar material(s).

The term “concrete tilt-up panel”, as used in this specification, includes any concrete slab or panel that is created by pouring fluid concrete into forms set out upon a hardened concrete floor surface. After curing, the panel side-forms are removed from the panel sides and the resulting tilt-up panel is removed from the floor surface and utilized as a component of the interior or exterior walls in the construction of a concrete structure.

The terms “edge form”, “side panel” and “panel form”, as used in this specification, include any solid material that is capable of being installed on top of a hardened concrete floor surface to serve as the edge or side of any form into which fluid concrete or other substance may be poured during the fabrication of a concrete tilt-up panel or similar item. For ease of reference, as used in this specification, the term “edge form” shall mean and include the terms “edge form”, “side form”, “panel form” and any other term designating a device suitable for such same or similar purpose.

The term “expansion joint material” as used in this specification is any suitable material that may be utilized to fill a gap of typically from ½ inch to 1 inch, commonly referred to as “expansion joints”, which are fabricated, formed or cut into structural surfaces at pre-determined intervals to allow for the naturally occurring expansion and contraction of the component materials which occurs as a result of changing temperatures.

The term “form-liner” or “form liner panel” as used in this specification includes any shaped material, including plastic, metal, compressed fiber, wood or rubber, that is attached to the inside of an upright poured-in-place concrete wall form to render a design, impression or shape within the exterior surface(s) of the completed poured-in-place concrete wall.

The term “MDF” as used in this specification is a construction industry abbreviation for “Medium Density Fiberboard” and is a type of hardboard which is made from wood fibers glued under heat and pressure.

The terms “reveal”, “reveal strip”, “feature strip”, “chamfer strip”, “detail strip”, “rustication strip” and “MDF strip”, as used in this specification, include any linear groove or indentation formed into the exterior surface of a concrete tilt-up panel at the time it is poured. For ease of reference, as used in this specification, the term “reveal strip” shall mean and include the terms “feature strip”, “blockout”, “chamfer strip”, “reveal strip”, “detail strip”, “rustication strip” and “MDF strip” and any other term designating a device suitable for such same or similar purpose.

The term “reveal” or “reveal strip” as used in this specification also includes any linear shaped material, including plastic, metal, compressed fiber, wood or rubber, that is attached to the inside of an upright poured-in-place concrete wall form to render a design, impression or shape within the exterior surface(s) of the completed poured-in-place concrete wall.

The term “reveal” as used in this specification also includes the finished linear impression or indented shape within the surface of a tilt-up wall panel.

The terms “reveal strip form”, “feature strip form”, “chamfer strip form”, “detail strip form”, “rustication strip”, as used in this specification, includes any solid material, including wood, plastic, metal or the like, that is capable of being shaped or sized and affixed to the surface of a concrete floor or other flat surface within the confines of an edge form. When fluid concrete is poured into the tilt-up panel form and over said reveal strip form, an impression or indentation is created in the surface of the tilt-up panel facing the floor surface in the transposed shape of the reveal strip form. Upon curing, the concrete tilt-up panel is lifted off of the floor surface by mechanical means and the reveal strip form remains attached to the floor, leaving an indented “reveal strip” or “reveal” in the space previously occupied by the reveal strip form during the pour.

The term “tilt-up structure” as used in this specification includes any structure constructed by means of utilizing poured concrete wall panels which have been formed on a horizontal surface and subsequently “tilted” or lifted into position to form the walls of said structure.

In modern times it has become common practice in the building of tilt-up structures to begin construction by pouring a concrete floor slab. When the floor slab surface has cured, edge forms for the concrete tilt-up panels are laid out on top of the floor surface. Fluid concrete is thereafter poured into the edge forms. When the concrete tilt-up panels have fully cured, they are lifted off of the floor surface into place by mechanical means and bolted together along the perimeter of the floor surface to form the exterior walls of the structure. Concrete tilt-up panels may likewise be used to construct some or all of the interior walls of a concrete structure.

To prevent a freshly-poured concrete tilt-up panel from adhering to the floor surfaces, a non-stick concrete releasing agent, commonly referred to as “bond-breaker”, is first applied to the floor surface before the pouring of the concrete tilt-up panel takes place.

In the event that the design plans and specifications call for the installation of a reveal strip within or along a portion of the exterior surface of a concrete tilt-up panel, workers will typically install a reveal strip form inside the perimeter of the edge form prior to the concrete pour. The reveal strip form must be securely attached to the floor surface so as to prevent movement and leakage during the concrete pour.

At the present time, two principal methods are utilized to secure the edge forms and/or reveal strip forms to the concrete floor surface during the fabrication of a concrete tilt-up panel:

### Method 1

An edge form and/or reveal strip form is located and marked on the surface of a concrete floor. Holes are drilled through the base surface of the edge form and/or reveal strip form into the concrete floor surface. The edge form and/or reveal strip form is temporarily removed from the floor surface and wooden or fiber pegs are inserted into the drilled holes in the concrete floor surface. The reveal strip form is then re-positioned in place and secured to the floor surface by means of nails or screws driven into the pegs, or driven directly into the holes. In a typical 40,000 square foot structure, more than 5,000 holes are drilled to secure the edge forms and reveal strip forms.

Following the pouring and curing of the concrete tilt-up panels and their subsequent removal from the concrete floor surface, the edge form and/or reveal strip form is removed from the concrete floor and each hole in the surface of the concrete floor is patched with an epoxy sealant. Visible nail head indentations remaining in the surface of the tilt-up panel are filled or smoothed.

Disadvantages of using this installation method include high labor costs to install and remove the forms and repair the concrete surfaces, extended completion times and permanent damage to the concrete floor surface resulting from the drilling and nailing process, including spalling of the floor surface adjacent to the drilled penetrations which may be further aggravated by heavy fork-lift traffic and sub-freezing weather conditions.

### Method 2

An edge form and/or reveal strip form is located and marked on the surface of a concrete floor slab. The edge form and/or reveal strip form is temporarily removed from the floor surface. A two-sided adhesive tape is applied to the base surface of the edge form and/or reveal strip form facing the concrete floor. Acetone and other solvents are required to remove the “bond-breaker” substance from the surface of the concrete floor over the areas where the edge form and/or reveal strip form is to be “taped” so that the adhesive material will stick. The edge form and/or reveal strip form with the two-sided adhesive tape affixed to it is then re-positioned upon the concrete floor surface, followed by the pouring of the fluid concrete into the space created by the edge form. Following the curing of the concrete tilt-up panel and its removal from the floor surface, glue residue from the tape adhesive must be removed from all concrete surfaces.

Disadvantages of using this installation method include high material and labor costs, extended completion times and deposit of adhesive residues that may be non-removable on some surfaces, resulting in permanent appearance flaws in the finished tilt-up panel or concrete floor, including unwanted lines, especially in connection with the use of colored concrete sealers. Further, the adherence qualities of the two-sided tape is adversely affected by moisture and humidity. The use of two-sided-tape in attaching edge forms and/or reveal strip forms is limited to dry weather projects and is utilized most effectively only in the southern-tier states.

Form-liner is used in the construction of poured-in-place upright concrete walls to render a design, impression or shape within the exterior surface(s) of the completed poured-in-place concrete wall. Present construction methods for affixing form-liner material to the inside wall of a pour-in-place concrete form is to utilize screws, nails or panel adhesives, such as silicon adhesives, “Liquid Nails”™, and other tube-dispensed adhesive products.

Disadvantages of the nailing or screwing method include the need to have laborers working on both sides of the forms during the installation process; the unavoidable creation of holes in the forms; the unavoidable creation of nail-head impressions in the finished concrete surfaces which require patching; time-consuming and labor-intensive removal and clean-up; buckling and warping of the forms around the nail or screw-heads.

Disadvantages of using tube-dispensed adhesive products to affix panel forms include time-consuming and labor-intensive removal and clean-up; sensitivity to moisture and humidity, resulting in failure of the adhesive and bulging; and sensitivity to chemicals in or upon the concrete forms resulting in failure of the adhesive and subsequent bulging, and messiness and difficulty in removing residue.

Reveal strips (or “reveal”), are also used in the construction of poured-in-place upright concrete walls to render a linear design, impression or shape within the exterior surface(s) of the completed poured-in-place concrete wall. Present construction methods for affixing reveal strip material to the inside wall of a pour-in-place concrete form is to utilize screws, nails or panel adhesives, such as silicon adhesives, “Liquid Nails”™, and other tube-dispensed adhesive products.

Disadvantages of the nailing or screwing method include the need to have laborers working on both sides of the forms during the installation process; the unavoidable creation of holes in the forms; the unavoidable creation of nail-head impressions in the finished concrete surfaces which require patching; time-consuming and labor-intensive removal and clean-up; buckling and warping of the reveal strips around the nail or screw-heads.

Disadvantages of using tube-dispensed adhesive products to affix reveal strips include time-consuming and labor-intensive removal and clean-up; sensitivity to moisture and humidity, resulting in failure of the adhesive and bulging; and sensitivity to chemicals in or on the concrete forms resulting in failure of the adhesive and subsequent bulging; messiness and difficulty in removing residue.

During construction of certain structures, such as bridges, buildings, roadways and other structures, gaps of typically from ½ inch to 1 inch, commonly referred to as “expansion joints”, are fabricated, formed or cut into structural surfaces at pre-determined intervals to allow for the naturally occurring expansion and contraction of the component materials which occurs as a result of changing temperatures. Whenever an expansion joint is called to be located between components of a structure or slab, it is necessary to fill in the gap with an expandable and contractible material (“expansion joint material”) that is capable of sealing the joint from penetrations of dirt, liquid, air and other elements.

To install expansion joint material, it is customary practice in the construction industry to attach some type of expansion joint material such as asphalt impregnated board, fiber board, rubber expansion joint filler, self-expanding cork, foam, closed-cell neoprene or other material(s) to the material surface of the first completed edge with nails or other penetrating fastening devices and then locate, pour or position the corresponding edge of the second material surface tightly against the previously installed expansion joint material, thus forming a completed expansion joint.

Disadvantages of using nails or other penetrating fastening devices to affix expansion joint material to the surface of a wall or slab edge include increased labor expense; work delay attributable to the time needed to nail the expansion joint material; where concrete is the material, spalling and other damage to the surface; and bowing or waving of the expansion joint material around nails or other fastening devices.

During the construction of concrete floor slabs, “expansion joints”, are frequently saw-cut into freshly-poured concrete surfaces at pre-determined intervals to allow for the naturally occurring expansion and contraction of the concrete material which occurs as a result of changing temperatures.

A common undesirable consequence of saw-cutting is that the cutting process produces spalling and ragged edges along the saw-cut edges of concrete surfaces.

### SUMMARY OF THE INVENTION

### First Embodiment

In accordance with the First Embodiment of the invention, there is provided an improved method for temporarily securing edge panel forms, wall panel forms, side panels, blockouts, chamfers, reveal strips, detail strips, feature strips, rustication strips, MDF strips or any other similar device(s) to a concrete floor surface wherein the surface of the edge form(s) intended to be made to adhere temporarily to the floor surface is coated with the adhesive material and the floor surface where the form and/or strip is to be temporarily attached is likewise coated with the adhesive material.

In accordance with the First Embodiment of the invention, after the adhesive material on both surfaces has sufficiently dried, the edge form or reveal strip form is positioned appropriately over its intended target location on the floor surface and pressed against said surface, thereby bonding the edge form or reveal strip form to the floor surface.

Advantages of using the First Embodiment of the invention to install edge forms and/or reveal strip forms include:
a. The adhesive material utilized in the present improved installation method adheres to floor surfaces treated with a non-stick concrete releasing agent, or “bond breaker”, thus eliminating the need to remove or prepare the non-stick surface material with solvents prior to installation of the edge form and/or reveal strip form.
b. The adhesive material utilized in the present improved installation method eliminates the need for drilling, nailing and the laborious forms-removal process.
c. The adhesive material utilized in the present improved installation method does away with the need for hole patching and other post-tilt-up floor repairs to the slab surface.
d. The adhesive material utilized in the present improved installation method, compared to the nail-down method, reduces overall installation time and expense, including labor, by approximately two-thirds.
e. The adhesive material utilized in the present improved installation method gives the decorative reveal a precise, well-defined appearance and greatly facilitates the imbedding of complex designs in the concrete wall surface.
f. The adhesive qualities of the adhesive material utilized in the present improved installation method is not materially affected by moisture or humidity and it is suitable for most wet or dry-weather installations where slab and surface temperatures exceed 33° F.
g. Upon completion of the fabrication of the concrete tilt-up panels, strips and forms installed with the adhesive material utilized in the present improved installation method are easily removed by inserting a flat blade or scraper under one end of a form or strip after the pour or lift-up of the wall panel.
h. Left-over adhesive material residue resulting from the present improved installation method is minimal and is easily removed from concrete surfaces by using a blade scraper, wire brush or high pressure water sprayer.

### Second Embodiment

In accordance with the Second Embodiment of the invention, there is provided an improved method for affixing form-liner material to the inside wall of a pour-in-place concrete form by means of coating the surface of the form-liner material with the adhesive material and likewise coating the pour-in-place concrete form where the form-liner material is to be temporarily attached with the adhesive material.

In accordance with the Second Embodiment of the invention, after the adhesive material on both surfaces has sufficiently dried, the form-liner is positioned appropriately over its intended target location on the pour-in-place form surface and pressed against said surface, thereby bonding the form-liner to the pour-in-place form surface.

Advantages of using the Second Embodiment of the invention to install form-liner include:
a. Eliminates the need to have laborers working on both sides of the forms during the installation process;
b. Eliminates the need to have holes in the forms;
c. Eliminates the need to have nail-head impressions in the finished concrete surfaces which require patching;
d. Eliminates the need for time-consuming and labor-intensive removal and clean-up;
e. Eliminates the buckling and warping of the forms around the nail or screw-heads.
f. Eliminates adhesive failures caused by moisture and humidity;
g. Eliminates adhesive sensitivity to chemicals in or upon the concrete forms resulting in failure of the adhesive and subsequent bulging; and
h. Eliminates extensive and expensive residue clean-up.
i. Allows multiple use of the pour-in-place concrete forms.

### Third Embodiment

In accordance with the Third Embodiment of the invention, there is provided an improved method for affixing reveal strip material to the inside wall of a pour-in-place concrete form by means of coating the surface of the reveal strip material with the adhesive material and likewise coating the pour-in-place concrete form where the reveal strip is to be temporarily attached with the adhesive material.

In accordance with the Third Embodiment of the invention, after the adhesive material on both surfaces has sufficiently dried, the reveal strip is positioned appropriately over its intended target location on the pour-in-place form surface and pressed against said surface, thereby bonding the reveal strip to the pour-in-place form surface.

Advantages of using the Third Embodiment of the invention to install reveal strips include:
a. Eliminates the need to have laborers working on both sides of the forms during the installation process;
b. Eliminates the need to have holes in the forms;
c. Eliminates the need to have nail-head impressions in the finished concrete surfaces which require patching;
d. Eliminates the need for time-consuming and labor-intensive removal and clean-up;
e. Eliminates the buckling and warping of the forms around the nail or screw-heads.
f. Eliminates adhesive failures caused by moisture and humidity;
g. Eliminates adhesive sensitivity to chemicals in or upon the concrete forms resulting in failure of the adhesive and subsequent bulging; and
h. Eliminates extensive and expensive residue clean-up.
i. Allows multiple use of the pour-in-place concrete forms.

### Fourth Embodiment

In accordance with the Fourth Embodiment of the invention, there is provided an improved method for affixing expansion joint material to the expansion surface of a pour-in-place concrete slab, wall or other solid material by means of spraying the facing surfaces of the expansion joint material and the concrete slab, wall or other solid material with the adhesive material.

In accordance with the Fourth Embodiment of the invention, after the adhesive material on both surfaces has sufficiently dried, the expansion joint material is positioned appropriately next to its intended target location on the concrete slab, wall or other solid material and pressed against said surface, thereby bonding the expansion joint material to the concrete slab, wall or other solid material. Where concrete is the expanding material, following contact, the adjoining pour-in-place concrete slab or wall is ready to pour immediately adjacent to the installed expansion joint material.

Advantages of using the Fourth Embodiment of the invention to install expansion joint material include:
a. Elimination of the need for using nails or other penetrating fastening devices to affix expansion joint material to the concrete slab expansion edge;
b. Substantial reduction labor expense;
c. Substantial reduction in work delays attributable to the time needed to nail the expansion joint material;
d. Elimination of spalling and other damage to concrete surfaces and bowing or waving of the expansion joint material around nails or other fastening devices.

### Fifth Embodiment

In accordance with the Fifth Embodiment of the invention, there is provided a method for the reduction of spalling and ragged edges along saw cut edges of concrete surfaces accomplished by means of coating the concrete surface to be cut with the specified adhesive material prior to making the saw cut.

In accordance with the Fifth Embodiment of the invention, after the location of a saw cut has been marked upon the surface of the concrete slab, a thin layer of adhesive material is applied along the length of the mark prior to making the saw cut.

Advantages of using the Fifth Embodiment of the invention include reduction of spalling and ragged edges along saw cut edges of concrete surfaces.

### BRIEF DESCRIPTION OF THE DRAWINGS

It is to be understood that the drawings are designed for the purpose of providing a better understanding of the invention, and to show how the same may be carried into effect. The drawings are not intended as a definition of the limits of the invention. Reference will now be made, by way of example, to the accompanying drawings, in which:

FIG. 1 is an overhead view illustrating a concrete floor slab coated with a bond-breaker material, with edge forms, reveal strips and block-outs installed thereon prior to the pouring of liquid concrete into the tilt-up panel edge-form, wherein 1 refers to the concrete floor slab covered with a bond-breaker material, 2 refers to the edge forms into which liquid concrete is to be poured, 3 refers to the reveal strips after they have been affixed to the bond-breaker material covering the concrete floor slab, 4 refers to a window block-out, 5 refers to a doorway blockout and 6 refers to a coating of bond-breaker,

FIG. 2 is a side view illustrating a concrete floor slab coated with bond-breaker material, where 1 refers to the concrete floor slab, 6 refers to the covering of bond-breaker material attached to the floor slab, 3 refers to the reveal strip attached to the adhesive and 7 refers to the layer of adhesive material attached to the bond-breaker and to the reveal strip,

FIG. 3 is a side view illustrating the installation of form-liner or reveal strip to the inside surface of a pour-in-place concrete form, where 8 refers to the form walls, 6 refers to the covering of bond-breaker material attached to the form, 7 refers to the layer of adhesive material attached to the bond-breaker and to the reveal strip and 9 refers to the form-liner or reveal strip which is attached to the adhesive material. Liquid concrete is poured into the space between the concrete form 8 and the form-liner or reveal strip 9,

FIG. 4 is a view depicting the back-side of a form-liner panel illustrating the recommended placement 10, 11 of adhesive material thereon in accordance with the described method for installing form-liner panels, and

FIG. 5 is a side view of the edge of a concrete slab or wall illustrating the installation of expansion-joint material thereon in accordance with the described method for installing same, where 12 refers to the concrete slab or wall, 13 refers to the concrete wall or slab edge, 14 refers to the layer of adhesive material which is sprayed onto the wall or slab edge, 15 refers to the expansion joint material which is placed against the adhesive, and 16 refers to the abutting concrete slab or wall that is poured-in-place following the installation of the expansion joint material.

### DETAILED DESCRIPTION OF THE INVENTION

A presently preferred embodiment of the invention will now be described with reference to the accompanying drawings:

### First Embodiment

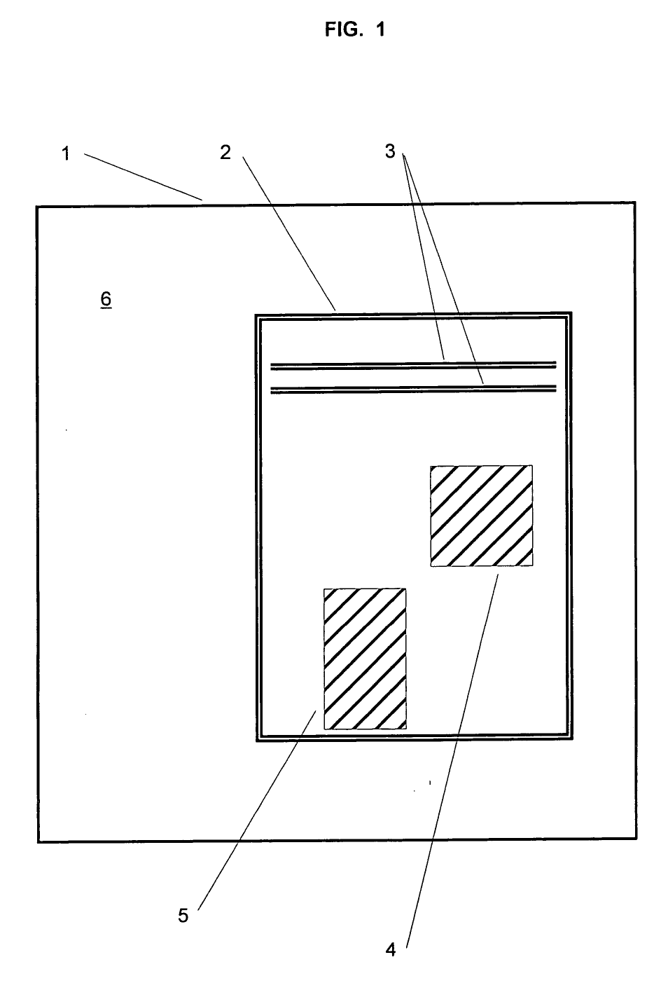

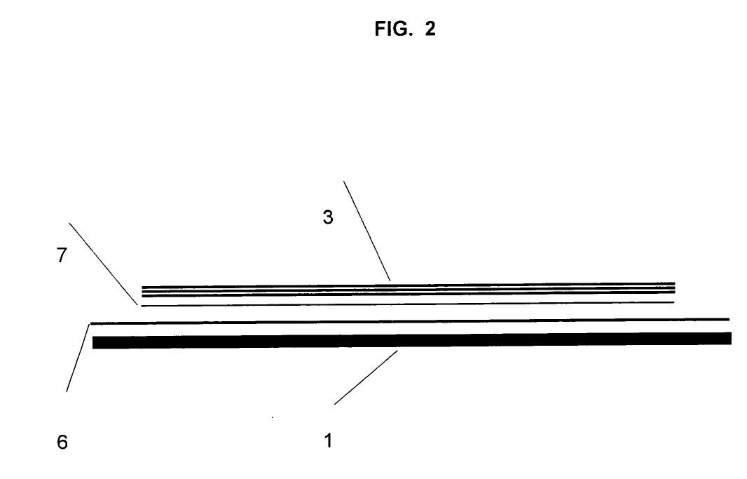

In accordance with the First Embodiment of the invention which pertains to an improved method for temporarily affixing strips 2 and forms 3 [FIG. 1] to a concrete floor slab 1 surfaced with a concrete releasing agent (“bond-breaker”) 6, it is preferred that at least two (2) coats of a suitable bond-breaker be applied to the concrete slab surface and allowed to cure before applying the adhesive material 7 [FIG. 2].

In accordance with the First Embodiment of the invention, it is preferred that all surfaces to be bonded be dry, and free from dust, oil, grease, loose paint, etc. It is preferred that the adhesive material not be applied to surfaces covered with standing water or during moderate to heavy rainfall. The adhesive material may be applied to wet or damp surfaces as described further, below. In accordance with the First Embodiment of the invention, it is preferred that the adhesive material be maintained in its storage container at a temperature during application of at least 45° F. (7.22° C.) or, preferably, above, and that the surface(s) to be bonded be at least 35° F. (1.66° C.) or above.

In accordance with the First Embodiment of the invention, it is preferred that Shopware, Inc. Spray Applicator Kit, Part No. 23L-45885-SW-KIT with the 95-degree (orange) spray tip, Part No. TP9501EVS-SW, installed, be used for applying the adhesive material.

In accordance with the First Embodiment of the invention, it is preferred that, while holding the spray nozzle 3 to 5 inches away from the concrete floor slab surface, that one (1) even coat of adhesive material be sprayed length-wise over the marked-off target area on the floor slab 1. It is preferred that standing or pooled water be removed with a “squeegee” or blower prior to application.

In accordance with the First Embodiment of the invention, it is preferred that, while holding the spray nozzle 3 to 5 inches away from the material surface, that one (1) even coat of adhesive material be sprayed length-wise over the contact edge of the blockout 4, 5, chamfer, reveal strip 3 [FIG. 1], detail strip, feature strip, rustication strip, MDF strip or similar device.

In accordance with the First Embodiment of the invention, it is preferred that, after the adhesive-coated surfaces have been allowed to become dry to touch, that the strip or other device 3 [FIGS. 1, 2] be aligned over the appropriate concrete slab target area and the surfaces joined together.

In accordance with the First Embodiment of the invention, it is preferred that, following attachment of the strip 3, a light coating of bond-breaker material be applied to the exposed strip surfaces to reduce the risk of spalling on the surface of the concrete wall panels following tilt-up and removal of the strips.

As pertains to the installation of edge forms 2 in accordance with the First Embodiment of the invention, it is preferred that after installing suitable angle bracketing devices or using a blocking method to prevent an overturn, the preferred method set forth above for affixing blackouts, chamfers and strips, etc., to a bond-breaker-treated surface be followed, except that it is preferred that two (2) coats of adhesive material be applied to each contact surface (floor slab 1 and edge form 2) due to the greater lateral pressures involved.

### Second Embodiment

In accordance with the Second Embodiment of the invention, which pertains to an improved method for temporarily affixing form-liner material 9 to the inside wall of a pour-in-place concrete form 8 surfaced with a concrete releasing agent (“bond-breaker”) 6, it is preferred that at least two (2) coats of a suitable bond-breaker agent be applied to the inside surfaces of the concrete forms and allowed to cure before applying the adhesive material.

In accordance with the Second Embodiment of the invention, it is preferred that all surfaces to be bonded be dry, and free from dust, oil, grease, loose paint, etc.

In accordance with the Second Embodiment of the invention, it is preferred that Shopware, Inc. Spray Applicator Kit, Part No. 23L-45885-SW-KIT with the 95-degree (yellow) spray tip, Part No. TP9501EVS-SW, installed, be used for applying the adhesive material.

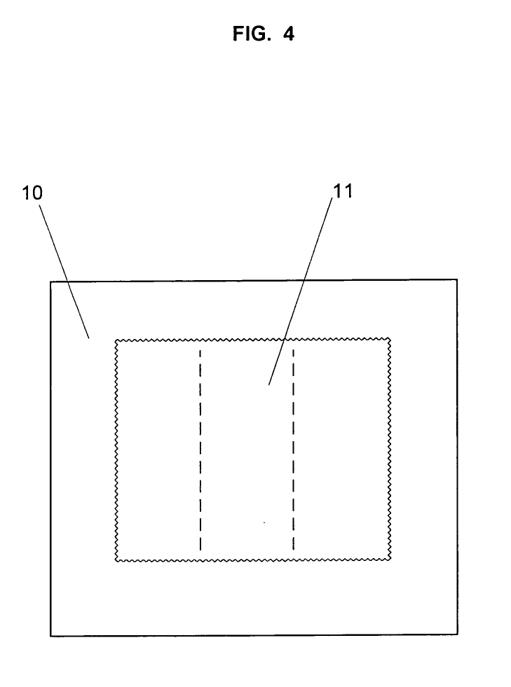

In accordance with the Second Embodiment of the invention, it is preferred that while holding the spray nozzle 3 to 5 inches away from the surface, that one (1) even coat of adhesive material be sprayed over (A) the outer one (1) foot wide surface area 10 [FIG. 4] of the form-liner material intended to be affixed to the inside wall 8 of a pour-in-place concrete form and over a one (1) foot wide vertical surface area 11 centered between the right and left edges of the aforesaid form-liner material, running from top to bottom between the formerly-described exterior one (1) foot wide sprayed areas; and (B), over the corresponding areas of the pour-in-place concrete form where the form-liner material is to be temporarily attached.

In accordance with the Second Embodiment of the invention, it is preferred that the adhesive-coated surfaces be allowed to become dry to touch. After the adhesive material 7 has properly dried, the form-liner material 9 is aligned over the appropriate pour-in-place concrete form target area, and the surfaces joined together.

### Third Embodiment

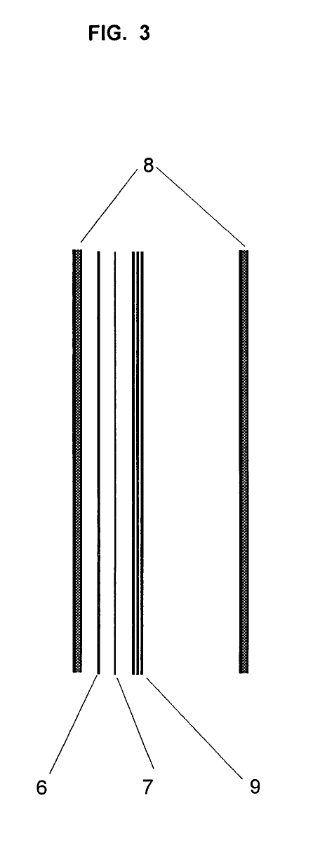

In accordance with the Third Embodiment of the invention, which pertains to an improved method for temporarily affixing reveal strip material 9 [FIG. 3] to the inside wall of a pour-in-place concrete form 8 surfaced with a concrete releasing agent (“bond-breaker”) 6, it is preferred that at least two (2) coats of a suitable bond-breaker agent be applied to the concrete slab surface and allowed to cure before applying the adhesive material.

In accordance with the Third Embodiment of the invention, it is preferred that all surfaces to be bonded be dry, and free from dust, oil, grease, loose paint, etc.

In accordance with the Third Embodiment of the invention, it is preferred that Shopware, Inc. Spray Applicator Kit, Part No. 23L-45885-SW-KIT with the 95-degree (orange) spray tip, Part No. TP9501EVS-SW, installed, be used for applying the adhesive material.

In accordance with the Third Embodiment of the invention, it is preferred that while holding the spray nozzle 3 to 5 inches away from the surface, one (1) even coat of adhesive material be sprayed length-wise over the contact surface of the reveal strip 9.

In accordance with the Third Embodiment of the invention, it is preferred that while holding the spray nozzle 3 to 5 inches away from the surface, one (1) even coat of adhesive material 7 be sprayed over the marked-off target area on the bond-breaker 6 affixed to the pour-in-place concrete form 8.

In accordance with the Third Embodiment of the invention, it is preferred that after the adhesive material has dried, that the reveal strip be aligned against the appropriate concrete form 8 target area and the respective surfaces be joined together.

### Fourth Embodiment

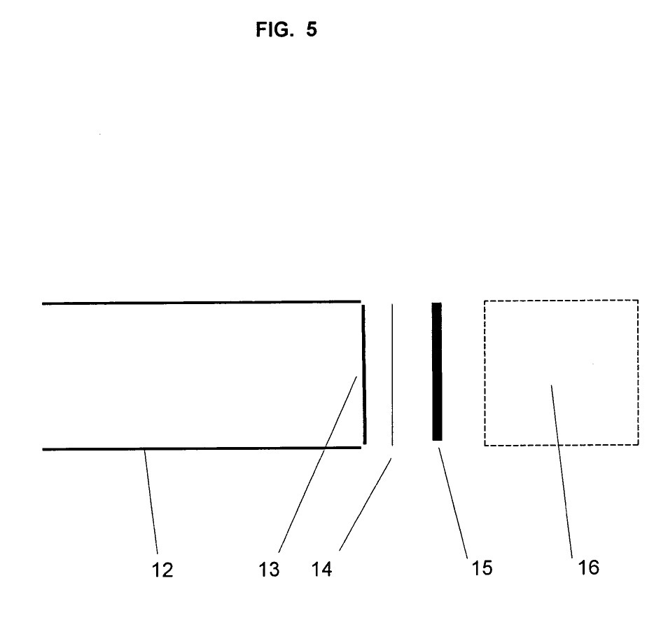

In accordance with the Fourth Embodiment of the invention, which pertains to an improved method for affixing expansion joint material 15 [FIG. 5] to the edge of a pour-in-place concrete slab or wall 13, or any other solid material, it is preferred that all surfaces to be bonded be dry, and free from dust, oil, grease, loose paint, etc. In accordance with the Fourth Embodiment of the invention, it is preferred that the adhesive material be maintained in its storage container at a temperature during application of at least 45° F. (7.22° C.) or, preferably, above, and that the surface(s) to be bonded be at least 35° F. (1.66° C.) or above.

In accordance with the Fourth Embodiment of the invention, it is preferred that Shopware, Inc. Spray Applicator Kit, Part No. 23L-45885-SW-KIT with the 95-degree (orange) spray tip, Part No. TP9501EVS-SW, installed, be used for applying the adhesive material.

In accordance with the Fourth Embodiment of the invention, it is preferred that while holding the spray nozzle 3 to 5 inches away from the edge surface, one (1) even coat of adhesive material 14 be sprayed over the target area on the surface of the concrete slab or wall 13 or other solid material.

In accordance with the Fourth Embodiment of the invention, it is preferred while holding the spray nozzle 3 to 5 inches away from the surface, that one (1) even coat of adhesive material be sprayed length-wise over the surface of the expansion joint material 15 which is to be attached to the wall, slab edge or other solid material.

It is preferred that the adhesive-coated surfaces be allowed to become dry to touch, after which time the expansion joint material 15 is aligned against the appropriate concrete wall, slab edge or other solid material target area 13, the surfaces are joined together and bonding occurs. Following contact, if the solid material is concrete, the adjoining pour-in-place concrete slab or wall is ready to pour immediately adjacent to the installed expansion joint material.

### Fifth Embodiment

In accordance with the Fifth Embodiment of the invention, which pertains to an improved method for reducing spalling and ragged edges along saw-cut edges of concrete surfaces, it is preferred that at least two (2) coats of a suitable bond-breaker agent be applied to the concrete slab surface and allowed to cure before applying the adhesive material.

In accordance with the Fifth Embodiment of the invention, it is preferred that all surfaces to be bonded be dry, and free from dust, oil, grease, loose paint, etc. It is preferred that the adhesive material not be applied to surfaces covered with standing water or during moderate to heavy rainfall. The adhesive material may be applied to wet or damp surfaces as described further, below. In accordance with the First Embodiment of the invention, it is preferred that the adhesive material be maintained in its storage container at a temperature during application of at least 45° F. (7.22° C.) or, preferably, above, and that the surface(s) to be bonded be at least 35° F. (1.66° C.) or above.

In accordance with the Fifth Embodiment of the invention, after the location of a saw-cut has been marked upon the surface of the concrete slab, one (1) even coat of adhesive material is applied along the length of the mark and allowed to dry prior to making the saw cut.

1. A method of forming a reveal impression in a concrete panel, comprising:
applying a coating of a releasing agent to a horizontal surface,
applying a layer of adhesive material to the coating of releasing agent,
applying a layer of adhesive material to a length of reveal strip,
placing the adhesive-coated reveal strip on the layer of adhesive on the concrete releasing agent,
pouring concrete over the coating of releasing agent and over the reveal strip, and
allowing the concrete to cure.

2. A method of forming an impression in a concrete surface utilizing a form-liner, comprising:
applying a coating of a releasing agent to a pour-in-place concrete form surface,
applying a layer of adhesive material to the coating of releasing agent,
applying a layer of adhesive material to the contact side of a form-liner,
placing the adhesive-coated form-liner against the layer of adhesive on the pour-in-place concrete form,
installing the pour-in-place concrete form with the attached form-liner so that the form-liner faces toward the opposite pour-in-place concrete form,
pouring liquid concrete in between the pour-in-place concrete forms, and
allowing the concrete to cure.

3. A method of forming a reveal in a concrete surface utilizing various solid materials, comprising:
applying a coating of a releasing agent to a pour-in-place concrete form surface,
applying a layer of adhesive material to the coating of releasing agent,
applying a layer of adhesive material to the contact side of a reveal strip,
placing the adhesive-coated reveal strip against the layer of adhesive on the pour-in-place concrete form,
installing the pour-in-place concrete form with the attached form-liner so that the form-liner faces toward the opposite pour-in-place concrete form,
pouring liquid concrete in between the pour-in-place concrete forms, and
allowing the concrete to cure.

4. A method of attaching expansion joint material to a solid surface, comprising:
applying a layer of adhesive material to the solid surface,
applying a layer of adhesive material to the contact side of the expansion joint material,
placing the adhesive-coated side of the expansion joint material against the layer of adhesive on the solid surface,
if the solid surface is concrete, installing a form to contain liquid concrete poured against the expansion joint material,
if the solid surface is concrete, pouring concrete into the form, and
allowing the concrete to cure.

5. A method for reducing spalling and ragged edges along saw-cut expansion joints cut into a concrete surface, comprising:
marking a saw-cut line upon the concrete surface,
applying an approximately 3-inch wide layer of a releasing agent to the concrete surface along the length of the saw-cut line,
applying adhesive material to the approximately 3-inch wide layer of a releasing agent along the length of the saw-cut line,
saw-cutting the concrete through the dried adhesive product and bond-breaker along the saw-cut line.
